(19) United States
(12) Patent Application Publication
(10) Pub. No.: US 2017/0261156 A1
(43) Pub. Date: Sep. 14, 2017

(54) COLLAPSIBLE LOOP HANGER APPARATUS

(71) Applicant: Gene Wise, Bonham, TX (US)

(72) Inventor: Gene Wise, Bonham, TX (US)

(21) Appl. No.: 15/453,531

(22) Filed: Mar. 8, 2017

Related U.S. Application Data
(60) Provisional application No. 62/306,376, filed on Mar. 10, 2016.

(51) Int. Cl. F16M 13/02; F16B 45/00

(52) U.S. Cl. CPC F16M 13/02; F16B 45/00

(57) ABSTRACT

A collapsible loop hanger apparatus includes a hook that has a hook portion and a stem portion. A sleeve receives the stem portion of the hook at a first end and receives a pair of ends of a cable at a second end opposite the first end, the cable forming a loop. A bead is configured to receive a double portion of the cable to allow adjustment of a size of the loop.

### PRIORITY CLAIM

This application claims the priority benefit of U.S. Provisional Application for Ser. No. 62/306,376 filed on Mar. 10, 2016, the contents of which is hereby incorporated by reference in its entirety to the maximum extent allowable by law.

### TECHNICAL FIELD

The present disclosure relates to a hanging apparatus, and more particularly to a hanger apparatus with an adjustable loop.

### BACKGROUND

Organization and storage of objects of various shapes and sizes at home or other locations is often challenging. For example, a fisherman may need to store one or more fishing rods in a generally upright orientation to maintain the rod in good condition and avoid damage to the rod when it is not being used.

### SUMMARY

A collapsible loop hanger apparatus includes a hook that has a hook portion and a threaded stem portion. A sleeve receives the stem portion of the hook at a first end and receives a pair of ends of a cable at a second end opposite the first end such that the cable forming a loop. A bead with a through hole receives and is displaceable along a double portion of the cable to allow adjustment of a size of the loop.

According to an alternate embodiment the bead may have two holes, through which each end of the cable is received. The two holes allow the bead to be displaced along the double portion of the cable to allow adjustment of a size of the loop.

According to an alternate embodiment of the present disclosure, a method of forming a collapsible loop hanger includes inserting a doubled portion of a cable into a bead such that the cable forms a loop. Two ends of the cable are inserted into a sleeve, and the sleeve is crimped with the inserted two ends of the cable to secure the two ends of the cable within the sleeve. A stem portion of a hook is screwed into the sleeve.

Technical advantages of the disclosed collapsible loop hanger apparatus include a loop hanger apparatus that accepts a variety of sized items and can secure the items in an upright position from which they remain undamaged and may easily be retrieved. Further technical advantages of the present disclosure include a collapsible loop hanger apparatus that is simple to fabricate from readily available hardware store off-the-shelf items.

Other technical advantages will be readily apparent to one of ordinary skill in the art from the following figures, descriptions, and claims. Moreover, while specific advantages have been enumerated above, various embodiments may include all, some, or none of the enumerated advantages.

### BRIEF DESCRIPTION OF THE DRAWINGS

A more complete understanding of the present invention may be acquired by reference to the following Detailed Description when taken in conjunction with the accompanying Drawings wherein:

FIG. 1 is a perspective view of an assembled collapsible loop hanger apparatus according to an embodiment of the present disclosure;

FIG. 2 is an exploded, perspective view of the collapsible loop hanger apparatus shown in FIG. 1; and

FIG. 3 is a perspective view of the collapsible loop hanger apparatus shown holding a fishing rod and hanging from a screw.

### DETAILED DESCRIPTION OF THE DRAWINGS

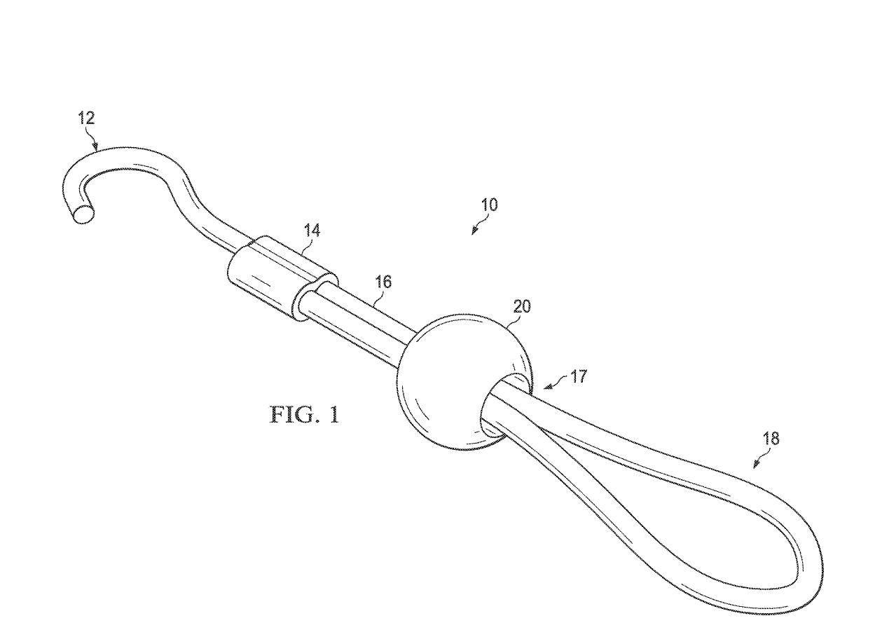

FIG. 1 is a perspective view of a collapsible loop hanger 10 according to the teachings of the present disclosure. The collapsible loop hanger 10 may be used to conveniently hang, store, and organize a variety of items. For example, the collapsible loop hanger 10 may be particularly well suited to hang one or more fishing rods. The collapsible loop hanger 10 secures an item by adjusting the size of the loop (i.e., expanding and collapsing the loop) to capture the item.

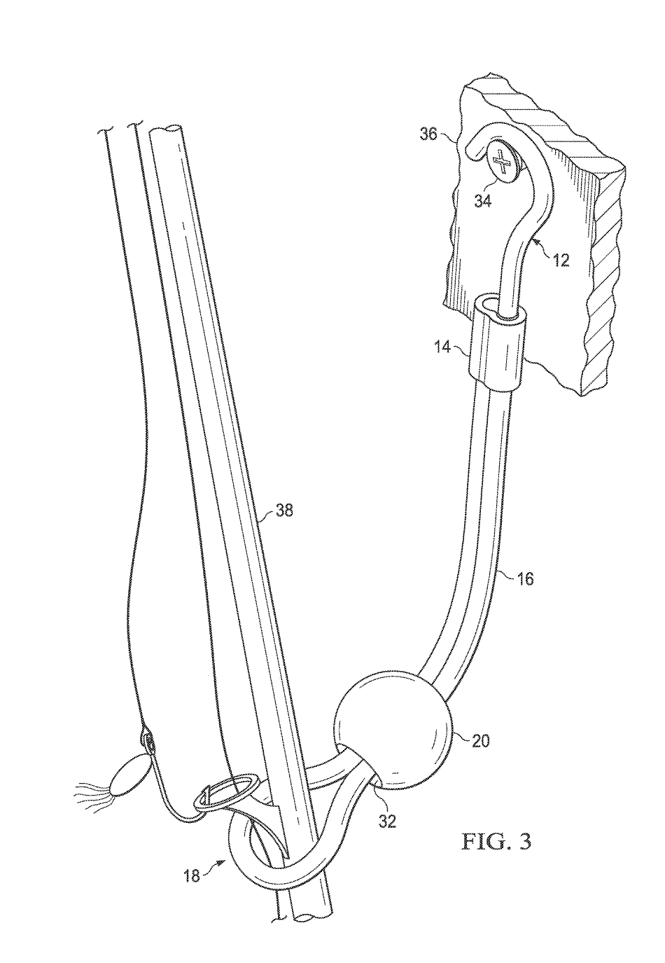

The collapsible loop hanger 10 includes a hook 12, a sleeve 14, a cable 16 forming a loop 18, and a displaceable bead 20. In FIG. 1, the bead 20 is shown in position proximate the sleeve 14 such that the loop 18 is in an expanded configuration. With the loop 18 in the expanded configuration, an item may be received by the loop 18, then the bead 20 may be displaced to collapse the loop 18 (see FIG. 3).

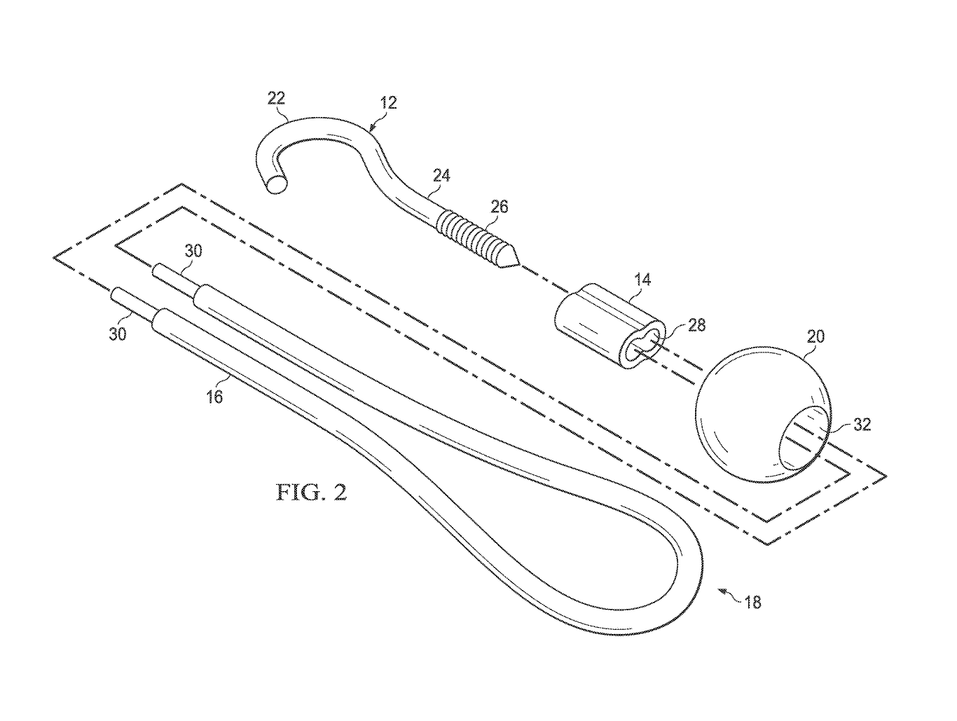

FIG. 2 is an exploded perspective view of the collapsible loop hanger 10 shown in FIG. 1. The hook 12 includes a hook portion 22 and a stem portion 24. The stem portion 24 includes threads 26. The hook 12 may be a commonly available metal screw hook that screws into a substrate, such as drywall, and secures the hook portion 22 in an orientation that allows items to be hung from the hook 12.

One side of the sleeve 14 receives the threaded stem portion 24 of the hook 12, and the other side of the sleeve 14 receives both ends of the cable 16 such that the cable forms the loop 18. The sleeve 14 may be formed of aluminum or any suitable material with a through hole 28. According to certain embodiments, the through hole 28 initially may be in the shape of a figure eight. The figure eight shape may be particularly well suited to receive two ends 30 of the cable 16. According to one embodiment the sleeve 14 may be a cable ferrule in aluminum that is designed to receive two ends 30 of the cable 16 with a specific diameter. The sleeve 14 may be any suitable length, for example, one half inch. For example, the sleeve 14 may include a through hole 28 sized to receive two ends 30 of the cable 16 having a diameter of ⅛ of an inch. Once the ends of the cable 16 are received in the sleeve 14, the sleeve 14 may be crimped with a tool, such as a swaging tool, to clamp the aluminum sleeve around the ends of the cable 16 and secure the cable within the sleeve 14. According to one embodiment the sleeve 14 may have two through holes, or a double through hole, each through hole configured to receive one end of the cable and be crimped.

The sleeve 14 may or may not include internal threads. According to one embodiment, the threads 26 of the stem portion 24 of the hook 12 can tap or otherwise cut threads into the material of the sleeve 14 as the threads 26 are rotated into the sleeve 14. Also, after inserting the two ends 30 of the cable 16 into the sleeve 14, the stem portion 24 of the hook 12 may be screwed into the sleeve 14 such that a wire portion of the two ends 30 of the cable 16 is caught and wrapped around the threads 26 to secure the two ends 30 of the cable 16 in the sleeve 14 to form the loop 18.

The bead 20 is inserted over the two ends 30 of the cable 16 prior to inserting the two ends 30 into the sleeve 14. The bead 20 has any suitable shape and defines a through hole 32 through which the two ends 30 of the cable 16 are fed. The bead 20 is displaceable along a doubled portion 17 of the cable 16 disposed within the through hole 32. According to one embodiment, the bead 20 may be a wooden bead that is generally spherical. The bead 20 may have a diameter of approximately one inch, and the through hole 32 may have a diameter of approximately three-eighths of an inch. Any suitable diameter bead 20 and any suitable diameter through hole 32 is contemplated by this disclosure, provided the diameter of the cable 16 when doubled inside the through hole 32 of the bead 20 is large enough such that the bead 20 does not slip off the loop 18.

The cable 16 may be any suitable cable and may have any suitable length. For example, the cable 16 may be a coated wire rope or cable, or a spring steel wire rope, and may be approximately one foot long. According to other embodiments, the length of the cable 16 may be in the range of 10 inches to two feet. In one embodiment, the cable 16 includes a metal wire surrounded by a polymer coating. However, in an alternate embodiment, the cable may be a non-coated wire cable and may be made of galvanized steel. According to one embodiment, the cable 16 has a diameter of ⅛ inch; however, any diameter in the range of 1/16 inch to ¼ inch is contemplated by this disclosure.

Reference is now made to FIG. 3, which shows the collapsible loop hanger 10 hanging from a screw 34 that is screwed into a wall 36, for example, a garage wall. The loop 18 is in a collapsed configuration and the bead 20 is displaced downward toward the loop-end of the cable 16. A rod portion 38 of a fishing rod is inserted through the loop 18. Once the rod portion 38 is through the loop 18, the bead 20 is directed downward to close and collapse the loop 18, which secures the rod portion 38. To remove the rod portion 38 from the loop 18, the bead 20 is displaced upward the cable 16 toward the hook 12 and the loop 18 is allowed to expand. The rod portion 38 may be easily removed from the expanded loop 18.

Although preferred embodiments of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A collapsible loop hanger apparatus, comprising:
a hook having a hook portion and a stem portion;
a sleeve receiving the stem portion of the hook at a first end and receiving a pair of ends of a cable at a second end opposite the first end, the cable forming a loop;
a bead configured to receive a double portion of the cable and configured to be displaceable along a double portion of the cable to allow adjustment of a size of the loop.

2. The apparatus of claim 1, wherein the bead has a single through hole defined therein, the single through hole receiving the pair of ends.

3. The apparatus of claim 1, wherein the bead has double through holes defined therein, the double through holes receiving the pair of ends.

4. The apparatus of claim 1, wherein the cable is a wire rope comprising a wire inside a coating.

4. The apparatus of claim 1, wherein the sleeve is formed of aluminum.

5. The apparatus of claim 1 wherein the bead is formed of wood.

6. The apparatus of claim 1, wherein the stem portion includes a threaded portion, wherein rotating the threaded portion into the sleeve taps corresponding threads into the sleeve.

7. The apparatus of claim 1, wherein the sleeve defines a single through hole configured to receive the pair of cable ends.

8. The apparatus of claim 7, wherein the single through hole configured has a figure eight pattern prior to crimping.

9. A method of forming a collapsible loop hanger, comprising:
inserting a doubled portion of a cable into a bead, the cable forming a loop;
inserting two ends of the cable into a sleeve;
crimping the sleeve with the inserted two ends of the cable to secure the two ends of the cable within the sleeve; and
attaching a stem portion of a hook to the sleeve.

10. The method of claim 9 wherein crimping the sleeve comprises inserting the sleeve into a swaging tool.

11. The method of claim 9 wherein attaching the stem portion taps threads into the sleeve.

12. An article comprising:
a hook having a hook portion and a stem portion;
a sleeve receiving the stem portion of the hook at a first end and receiving a pair of ends of a cable at a second end opposite the first end, the cable forming a loop;
at least one member having a through hole defined therein that receives a doubled portion of the cable and that is slidable along the doubled portion of the cable to allow adjustment of a size of the loop.

13. The article of claim 12, wherein the at least one member comprises a bead.

14. The article of claim 13, wherein the bead has a spherical shape.
